(19) United States
(12) Patent Application Publication
(10) Pub. No.: US 2026/0188541 A1
(43) Pub. Date: Jul. 2, 2026

(54) INSULATOR

(71) Applicant: NGK INSULATORS, LTD., Nagoya-shi (JP)

(72) Inventors: Takanori KONDO, Kasugai-shi (JP); Tomoya IIZUKA, Hashima-gun (JP)

(21) Appl. No.: 19/399,859

(22) Filed: Nov. 25, 2025

(30) Foreign Application Priority Data
Nov. 26, 2024 (JP) 2024-205592

(51) Int. Cl. H01B 17/02

(52) U.S. Cl. CPC H01B 17/02

(57) ABSTRACT

An insulator includes a core having a rod-shape, a first end fitting and a second end fitting that secure both ends of the core in an axial direction of the core, and a housing that covers an outer periphery of a portion of the core, the portion being located between the first end fitting and the second end fitting wherein the housing includes a first region and a second region, the first region that is provided at a position including an interface between the first end fitting and the housing in the axial direction, and the second region that is provided at a position adjacent to the first region and closer to the second end fitting than the first region in the axial direction, and the first region has a lower resistivity than the second region.

### CROSS-REFERENCE TO RELATED APPLICATION

The present application is based upon and claims the benefit of priority from Japanese Patent Application No. 2024-205592,filed on Nov. 26, 2024, the entire contents of which are

incorporated herein by reference.

### BACKGROUND OF THE INVENTION

### 1. Field of the Invention

The present invention relates to an insulator.

### 2. Description of the Related Art

Hitherto, an insulator that supports a conductor such as a transmission line and insulates between the transmission line and a steel tower or other equipment has been known. For example, PTL 1 describes a composite insulator including: a core; a housing provided on an outer periphery of the core and having a trunk portion and a plurality of sheds; and end fittings provided at both ends of the core. In manufacturing the composite insulator, the housing is molded around the core, after which the end fittings are set on both ends of the core, and the end fittings are compressed with dies to be tightened.

### CITATION LIST

### Patent Literature

PTL 1: JP 2001-332147 A

### SUMMARY OF THE INVENTION

In such insulators, corona discharge sometimes occurred due to the electric field concentration around the interface between the housing and the end fitting connected to the transmission line and so forth, i.e., the energized end, of the end fittings at both ends. Therefore, it was desirable to suppress corona discharge by mitigating the electric field concentration around the interface between the end fitting and the housing.

The present invention was made to solve such a problem, and its main object is to mitigate the electric field concentration around the interface between the first end fitting and the housing.

The present invention employs the following configuration to achieve the above-described main object.
[1] An insulator according to the present invention is an insulator including: a core having a rod-shape, a first end fitting and a second end fitting that secure both ends of the core in an axial direction of the core, and a housing that covers an outer periphery of a portion of the core, the portion being located between the first end fitting and the second end fitting, the housing having a trunk portion and a plurality of sheds, and being composed of an insulating polymer material as a main component, wherein the housing includes a first region and a second region, the first region that is provided at a position including an interface between the first end fitting and the housing in the axial direction, and the second region that is provided at a position adjacent to the first region and closer to the second end fitting than the first region in the axial direction, and the first region has a lower resistivity than the second region.

In this insulator, the housing has the first region and the second region. The first region is provided at the position including the interface between the first end fitting and the housing in the axial direction of the core. The second region is provided at the position adjacent to the first region and closer to the second end fitting than the first region in the axial direction. The first region has a lower resistivity than the second region. With this configuration, it is possible to mitigate the electric field concentration around the interface between the first end fitting and the housing, that is, around the interface between the first end fitting and the first region.
[2] In the above insulator (the insulator described in [1]), the plurality of sheds may have two or more types of sheds with different diameters, and the diameter of the shed located closest to the second region in the first region may be larger than the diameter of the shed located closest to the first region in the second region. In this manner, contrary to the above, as compared to the case where the diameter of the shed located closest to the second region in the first region is smaller than the diameter of the shed located closest to the first region in the second region, the electric field concentration around the interface between the first region and the second region can be mitigated when the first end fitting is used as the energized end. In this case, the plurality of sheds may be arranged alternately along the axial direction in two types: a large diameter shed and a small diameter shed. In the present specification, “resistivity” means volume resistivity.
[3] In the above insulator (the insulator described in [1] or [2]), the housing may have a third region provided at a position adjacent to the second region and closer to the second end fitting than the second region in the axial direction, and the third region may have a higher resistivity than the second region. In this manner, by making the resistivity of the first region, the second region, and the third region of the housing increase in this order, it is possible to increase the resistivity of the third region while reducing the difference in resistivity between the first region and the second region and the difference in resistivity between the second region and the third region. Therefore, compared to a case where the housing has only the first region and the second region, it is easy to obtain both an effect of mitigating an electric field concentration around the interface between the first end fitting and the first region by lowering the resistivity of the first region, and an effect of mitigating an electric field concentration around the interface between regions of the housing having different resistivities.
[4] In the above insulator (the insulator described in any one of [1] to [3]), the insulator may be used for insulating electrical equipment with a nominal voltage of 161 kV or less, and the first region may have a resistivity R1 of 6.0×10¹² Ω·cm or less. In this manner, when the insulator is used for insulating electrical equipment with such a nominal voltage, the electric field concentration around the interface between the first end fitting and the first region is sufficiently mitigated.
[5] In the above insulator (the insulator described in any one of [1] to [4]), the insulator may be used for insulating electrical equipment with a nominal voltage of 161 kV or less, and when the length of the first region in the axial direction is defined as L1 [mm], and log₁₀ (R2/R1), which is a common logarithm of a ratio of a resistivity R1 [Ω·cm] of the first region to a resistivity R2 [Ω·cm] of the second region, is defined as a resistance ratio Rr, and e is defined as Napier's constant, the following equation (1) may be satisfied.

$$Rr \leq 0.00903818763 {e}^{0.00675775192 L 1} \qquad ( 1 )$$

Here, the electric field concentration around the interface between the first region and the second region tends to be mitigated as the resistance ratio Rr between the first region and the second region becomes smaller. In addition, when the first end fitting is used as the energized end, the electric field concentration around the interface between the first region and the second region tends to be mitigated as the length L1 of the first region becomes longer, since the longer the length L1 of the first region, the further the interface between the first region and the second region is separated from the first end fitting. Then, for example, if the length L1 is sufficiently long, the electric field concentration can be mitigated even if the resistance ratio Rr is large. Thus, one of the values of the length L1 and the resistance ratio Rr affects the preferred range of the other value. The inventors have found the above equation (1) as the preferred range of the length L1 and the resistance ratio Rr, taking into account the above effects. By satisfying this equation (1) for the length L1 and the resistance ratio Rr, the electric field concentration around the interface between the first region and the second region can be mitigated when the insulator is used for insulating electrical equipment with the nominal voltage of 161 kV or less, and the first end fitting is used as the energized end.
[6] In the above insulator (the insulator described in [5]), the following equation (2) may be satisfied. In this manner, by satisfying equation (2) for the length L1 and resistance ratio Rr, the electric field concentration around the interface between the first region and the second region can be further mitigated when the first end fitting is used as the energized end.

$$Rr \leq 0.0074 {e}^{0.0069 L 1} \qquad ( 2 )$$

[7] In the above insulator (the insulator described in any one of [1] to [6]), the insulator may be used for insulating electrical equipment with a nominal voltage of 345 kV or less, and the first region may have a resistivity R1 of 3.0×10¹² Ω·cm or less. In this manner, when the insulator is used for insulating this voltage, the electric field concentration at the interface between the first end fitting and the first region is sufficiently mitigated.
[8] In the above insulator (the insulator described in any one of [1] to [7]), the insulator may be used for insulating electrical equipment with a nominal voltage of 345 kV or less, and when the length of the first region in the axial direction is defined as L1 [mm], and log₁₀ (R2/R1), which is a common logarithm of a ratio of a resistivity R1 [Ω·cm] of the first region to a resistivity R2 [Ω·cm] of the second region, is defined as a resistance ratio Rr, and e is defined as Napier's constant, the following equation (3) may be satisfied.

$$Rr \leq 0.0023 {e}^{0.0064 L 1} \qquad ( 3 )$$

The inventors of the present invention have found that, as in the above equation (1), the above equation (3) is a preferred range for the length L1 and resistance ratio Rr when the insulator is used for insulating electrical equipment with a nominal voltage of 345 kV or less. By satisfying this equation (3) for the length L1 and the resistance ratio Rr, the electric field concentration around the interface between the first region and the second region can be mitigated when the insulator is used for insulating electrical equipment with the nominal voltage of 345 kV or less, and the first end fitting is used as the energized end.
[9] In the above insulator (the insulator described in [8]), the following equation (4) may be satisfied. In this manner, by satisfying equation (4) for the length L1 and resistance ratio Rr, the electric field concentration around the interface between the first region and the second region can be further mitigated when the first end fitting is used as the energized end.

$$Rr \leq 0.0026 {e}^{0.0061 L 1} \qquad ( 4 )$$

### BRIEF DESCRIPTION OF THE DRAWINGS

FIG. 1 is an explanatory diagram of an insulator device 1.

FIG. 2 is an explanatory diagram of an interface 34b according to a modification.

FIG. 3 is an explanatory diagram of a housing 30 having a third region 33.

FIG. 4 is a graph showing a distribution of an electric field strength of an insulator 10 in Experimental Example 1.

FIG. 5 is a graph showing a distribution of the electric field strength of the insulator 10 in Experimental Example 2.

FIG. 6 is a graph showing a distribution of the electric field strength of the insulator 10 in Experimental Example 3.

FIG. 7 is a graph showing a distribution of the electric field strength of the insulator 10 in Experimental Example 4.

FIG. 8 is a graph showing a relationship between a resistivity R1 and a length D in each of Experimental Examples 5 to 7.

FIG. 9 is a graph showing a relationship between the resistivity R1 and the length D in each of Experimental Examples 8 to 10.

FIG. 10 is a graph showing a relationship between a resistance ratio Rr, a length L1, and an evaluation result in each of Experimental Examples 11 to 21.

FIG. 11 is a partial enlarged view of FIG. 10.

FIG. 12 is a partial enlarged view of FIG. 10.

FIG. 13 is a partial enlarged view of FIG. 10.

FIG. 14 is a graph showing a relationship between the resistance ratio Rr, the length L1, and the evaluation result for each of Experimental Examples 22 to 34.

FIG. 15 is a partial enlarged view of FIG. 14.

FIG. 16 is a partial enlarged view of FIG. 14.

FIG. 17 is a partial enlarged view of FIG. 14.

### DETAILED DESCRIPTION OF THE INVENTION

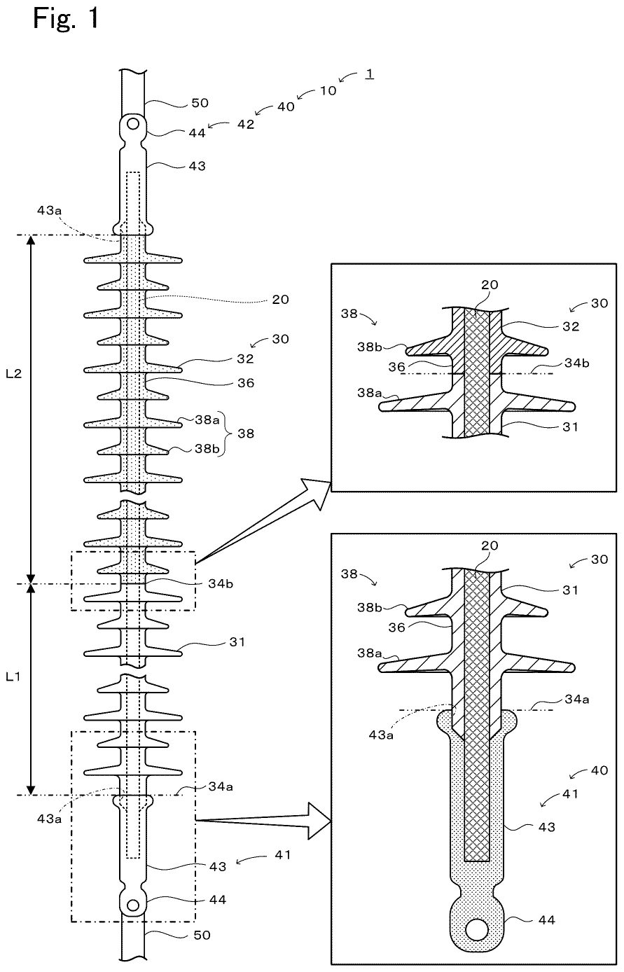

Next, embodiments of the present invention will be described with reference to the drawings. FIG. 1 is an explanatory diagram of an insulator device 1 including an insulator 10 of the present invention. The two enlarged views in FIG. 1 show a vicinity of an interface 34b and a vicinity of a first end fitting 41 in a cross section of the insulator 10 cut along a center axis of a core 20.

The insulator device 1 is used to support a conductor such as a transmission line and to insulate the conductors from a steel tower or other equipment. As illustrated in FIG. 1, the insulator device 1 includes the insulator 10 and a connecting member 50. The insulator 10 is a main body (insulator main body) of the insulator device 1 and includes the core 20, a housing 30, and an end fitting 40. In the present embodiment, the insulator 10 is used in a state in which the lower end side of the insulator 10 shown in FIG. 1 is connected to a conductor such as a transmission line and the upper end side of the insulator 10 is connected to a steel tower or other equipment. Therefore, the lower end side of the insulator 10 shown in FIG. 1 is also referred to as the energized end, and the upper end side of the insulator 10 is also referred to as the ground end.

The core 20 is a rod-shaped member having insulating properties. Examples of a material of the core 20 include Fiber Reinforced Plastics (FRP). Examples of fibers included in the FRP include glass fibers and so forth. Examples of plastics included in the FRP include epoxy resin and polyester resin and so forth. In the present embodiment, the core 20 is a solid cylindrical member, but the core 20 may also be a hollow cylindrical member.

The housing 30 is an insulating member provided on the outer periphery of the core 20. In the present embodiment, the housing 30 is configured as flexible insulating materials. The housing 30 is composed of an insulating polymer material as a main component, and therefore the insulator 10 is configured as a composite insulator. Embodiments of polymer materials include silicone rubber, EPDM (ethylene-propylene-diene-monomer) rubber, EVA (ethylene-vinyl-acetate), and more specifically, silicone rubber vulcanized at high temperatures. The housing 30 includes a trunk portion 36 and a shed 38. The trunk portion 36 has a substantially constant diameter and is arranged so as to cover the outer peripheral surface of the core 20. The shed 38 has a larger diameter than the trunk portion 36 and is formed so as to project radially outward from the outer peripheral surface of the trunk portion 36. The sheds 38 are arranged in a plurality spaced apart along an axial direction (up-down direction in FIG. 1) of the core 20. The plural sheds 38 have two types of sheds 38 with different diameters, specifically, a large diameter shed 38a and a small diameter shed 38b with a diameter smaller than that of the large diameter shed 38a. The large diameter sheds 38a and the small diameter sheds 38b are arranged alternately one by one along the axial direction. Each of the plurality of sheds 38 has an upper surface that is inclined in FIG. 1. More specifically, each upper surface of the sheds 38 is more inclined from the direction perpendicular to the axial direction than the lower surface. The insulator 10 is basically used with the inclined surfaces of the plurality of sheds 38 facing the ground end. The housing 30 has a first region 31 and a second region 32. The first region 31 and the second region 32 each have a plurality of large diameter sheds 38a and a plurality of small diameter sheds 38b. Details of the first region 31 and the second region 32 will be described later.

The end fitting 40 is a metal member that covers and secures both ends of the core 20 in the axial direction. The end fitting 40 has a first end fitting 41 that secures one end (the lower end in FIG. 1) of the core 20 and a second end fitting 42 that secures the other end (the upper end in FIG. 1) in the axial direction. Examples of the end fitting 40 include carbon steel and ductile cast iron and so forth. The first end fitting 41 and the second end fitting 42 are arranged symmetrically in the up-down direction. The first end fitting 41 and the second end fitting 42 each include a main body 43 and a connecting portion 44.

The main body 43 is a cylindrical member having an insertion bore 43a with a bottom formed along the center axis. The end of the core 20 is inserted into this insertion bore 43a. A tightening portion is formed in the main body 43, and in the portion where the tightening portion exists, the inner peripheral surface of the insertion bore 43a presses the core 20, thereby the end fitting 40 secures the core 20. With this configuration, the tensile strength of the insulator 10 in the axial direction is maintained at a required value (e.g., a value obtained by adding a margin to the tensile strength applied between the transmission line and the steel tower). Although not shown in the figure, the portion of the outer peripheral surface of the main body 43 where the tightening portion exists is slightly concave compared to other portions. In other words, the diameter of the portion of the main body 43 where the tightening portion exists is smaller than the diameter of other portions (the diameter is reduced). As illustrated in the enlarged view at the lower right of FIG. 1, not only the lower end of the core 20 but also the lower end of the housing 30 is inserted into the insertion bore 43a of the first end fitting 41. Similarly, not only the upper end of the core 20 but also the upper end of the housing 30 is inserted into the insertion bore 43a of the second end fitting 42.

The connecting portion 44 is provided on the outside (end side) of the main body 43 in the axial direction of the insulator 10. The connecting portion 44 is a portion for connecting the end portion of the insulator 10 in the axial direction to the connecting member 50. The connecting portion 44 is connected to the connecting member 50 by using, for example, a bolt and a nut not shown in the figure.

The connecting member 50, the detailed illustration of which is omitted, is for connecting the insulator device 1 to other members. The insulator device 1 has two connecting members 50, and the two connecting members 50 are provided one each at both ends of the insulator 10 in the axial direction and are connected to the connecting portion 44 of the end fitting 40. In the present embodiment, the connecting member 50 located at the upper end of FIG. 1 is configured as a mounting hardware for connecting the second end fitting 42 of the insulator device 1 to the steel tower, and the connecting member 50 located at the lower end of FIG. 1 is configured as a line fitting for connecting the first end fitting 41 of the insulator device 1 to the transmission line.

The first region 31 and second region 32 of the housing 30 are described in detail below. The first region 31 is provided at a position including the interface 34a between the first end fitting 41 and the housing 30 in the axial direction of the core 20. The interface 34a is the end portion of the first end fitting 41 on the side of the second end fitting 42 (the upper end of the first end fitting 41 in FIG. 1). The interface 34a is the end of the first area 31 on the side of the first end fitting 41 (the lower end of the first area 31 in FIG. 1), and the first area 31 is the area of the housing 30 extending upward from this interface 34a to a length L1 [mm] in the axial direction of the core 20. The second region 32 is provided at a position adjacent to the first region 31 and closer to the second end fitting 42 than the first end fitting 41 in the axial direction of the core 20. The first region 31 and the second region 32 are in contact with each other in the up-down direction at the interface 34b. The interface 34b is the end portion of the first region 31 on the side of the second region 32 (the upper end of the first region 31 in FIG. 1) and the end portion of the second region 32 on the side of the first region 31 (the lower end of the second region 32 in FIG. 1). The second region 32 is the region of the housing 30 extending upward from this interface 34b to a length L2 [mm] in the axial direction of the core 20. In the present embodiment, in the axial direction of the core 20, the position of the upper end of the second region 32 is the same as the position of the end portion of the second end fitting 42 on the side of the first end fitting 41 (the lower end of the second end fitting 42 in FIG. 1). Therefore, the first region 31 and the second region 32 of the housing 30 completely cover the outer periphery of the portion of the core 20 between the first end fitting 41 and the second end fitting 42. In addition, the sum of the length L1 and the length L2 is equal to the distance between the first end fitting 41 and the second end fitting 42.

Furthermore, the first region 31 has a lower resistivity than the second region 32. That is, the resistivity R1 [Ω·cm] of the first region 31 is lower than the resistivity R2 [Ω·cm] of the second region 32. Such a configuration can mitigate an electric field concentration around the interface between the first end fitting 41 and the housing 30, i.e., around the interface 34a between the first end fitting 41 and the first region 31. In particular, when the first end fitting 41 is used as the energized end, an electric field tends to be concentrated at the interface 34a, but in the insulator 10 of the present embodiment, the electric field concentration at the interface 34a can be mitigated because the resistivity R1 of the first region 31 is low. Such a configuration suppresses corona discharge around the interface 34a during use of the insulator 10.

When the insulator 10 is used for insulating electrical equipment with a nominal voltage of 161 kV or less (e.g., insulating between the transmission line and the steel tower mentioned above), the resistivity R1 is preferably 6.0×10¹² Ω·cm or less. In this manner, when the insulator 10 is used for insulating electrical equipment with such a nominal voltage, the electric field concentration around the interface 34a is sufficiently mitigated. The resistivity R1 may be 8.0×10¹¹ Ω·cm or more.

In addition, when the insulator 10 is used for insulation of electrical equipment with the nominal voltage of 161 kV or less, log₁₀ (R2/R1), which is a common logarithm of the ratio of the resistivity R1 of the first region 31 to the resistivity R2 of the second region 32, is defined as the resistance ratio Rr, and e is defined as Napier's constant, the relationship between the length L1 of the first region 31 and the resistance ratio Rr preferably satisfy the following equation (1). The resistance ratio Rr=log₁₀ (R2/R1), and this equation can also be rewritten as R2/R1=10^{Rr}. Therefore, the resistance ratio Rr is a power of 10 of the ratio R2/R1.

$$Rr \leq 0.00903818763 {e}^{0.00675775192 L 1} \qquad ( 1 )$$

Here, the electric field concentration around the interface 34b between the first region 31 and the second region 32 tends to be mitigated as the resistance ratio Rr between the first region 31 and the second region 32 becomes smaller. In addition, when the first end fitting 41 is used as the energized end, the electric field concentration around the interface 34b tends to be mitigated as the length L1 of the first region 31 becomes longer, since the longer the length L1 of the first region 31, the further the interface 34b is separated from the first end fitting 41. Then, for example, if the length L1 is sufficiently long, the electric field concentration at the interface 34b can be mitigated even if the resistance ratio Rr is large, and thus one of the values of the length L1 and the resistance ratio Rr affects the preferred range of the other value. Equation (1) represents the preferred range of the length L1 and the resistance ratio Rr, taking into account the above effects. By satisfying this equation (1) for the length L1 and the resistance ratio Rr, the electric field concentration around the interface 34b can be mitigated when the insulator 10 is used for insulating electrical equipment with the nominal voltage of 161 kV or less, and the first end fitting 41 is used as the energized end,

It is more preferable that the relationship between the length L1 and the resistance ratio Rr satisfy the following equation (2). In this manner, by satisfying equation (2) for the length L1 and the resistance ratio Rr, the electric field concentration around the interface 34b can be further mitigated.

$$Rr \leq 0.0074 {e}^{0.0069 L 1} \qquad ( 2 )$$

As described above, the smaller the resistivity R1 of the first region 31, the more the electric field concentration around the interface 34a between the first end fitting 41 and the first region 31 can be mitigated. On the other hand, the smaller the resistivity R1, the larger the resistance ratio Rr tends to be, so the electric field tends to be concentrated around the interface 34b between the first region 31 and the second region 32. Therefore, there is a trade-off relationship between the mitigation of electric field concentration around interface 34a and the mitigation of electric field concentration around interface 34b. The insulator 10 of present embodiment, when used for insulating electrical equipment with the nominal voltage of 161 kV or less, can achieve both mitigation of electric field concentration around interface 34a and mitigation of electric field concentration around interface 34b by making resistivity R1 small and satisfying equation (1). In addition, by making the resistivity R1 small and satisfying equation (2), it is possible to mitigate the electric field concentration around the interface 34a while further mitigating the electric field concentration around the interface 34b. As described above, when the insulator 10 is used for insulating electrical equipment with the nominal voltage of 161 kV or less, it is preferable that the resistivity R1 be 6.0×10¹² Ω·cm or less. Therefore, it is preferable that the insulator 10 has a resistivity R1 of 6.0×10¹² Ω·cm or less and satisfies equation (1). It is more preferable that the insulator 10 has a resistivity R1 of 6.0×10¹² Ω·cm or less and satisfies equation (2).

When the resistivity R1 is 6.0×10¹² Ω·cm or less, and/or when the above equation (1) is satisfied, the insulator 10 can be used for insulating electrical equipment with the nominal voltage of 161 kV or less, as described above. In this case, the insulator 10 is particularly suitable for insulating electrical equipment with a nominal voltage of any value of 115 kV or more and 161 kV or less, or for insulating electrical equipment with a nominal voltage of any value of 154 kV or more and 161 kV or less.

When the insulator 10 is used for insulating electrical equipment with a nominal voltage of 345 kV or less, the resistivity R1 is preferably 3.0×10¹² Ω·cm or less. In this manner, when the insulator 10 is used for insulating electrical equipment with such a nominal voltage, the electric field concentration around the interface 34a is sufficiently mitigated. The resistivity R1 may be 1.0×10¹² Ω·cm or more.

In addition, when the insulator 10 is used for insulating electrical equipment with the nominal voltage of 345 kV or less, it is preferable that the relationship between the length L1 of the first region 31 and the resistance ratio Rr satisfy the following equation (3).

$$Rr \leq 0.0023 {e}^{0.0064 L 1} \qquad ( 3 )$$

When the insulator 10 is used for insulating electrical equipment with the nominal voltage of 345 kV or less and the first end fitting is used as the energized end, there are also preferred range for the length L1 and the resistance ratio Rr, as in the above equation (1). Specifically, by satisfying the above equation (3), the electric field concentration around the interface 34b can be mitigated.

In addition, it is more preferable that the relationship between the length L1 and the resistance ratio Rr satisfy the following equation (4). In this manner, by satisfying equation (4) between the length L1 and the resistance ratio Rr, the electric field concentration around the interface 34b can be further mitigated.

$$Rr \leq 0.0026 {e}^{0.0061 L 1} \qquad ( 4 )$$

As mentioned above, there is the trade-off relationship between the mitigation of electric field concentration around interface 34a and the mitigation of electric field concentration around interface 34b. In the insulator 10 of present embodiment, when used for insulating electrical equipment with the nominal voltage of 345 kV or less, by making the resistivity R1 small and satisfying equation (3), it is possible to achieve both mitigation of electric field concentration around interface 34a and mitigation of electric field concentration around interface 34b. In addition, by making the resistivity R1 small and satisfying equation (4), it is possible to mitigate the electric field concentration around the interface 34a while further mitigating the electric field concentration around the interface 34b. As described above, when the insulator 10 is used for insulating electrical equipment with the nominal voltage of 345 kV or less, it is preferable that the resistivity R1 be 3.0×10¹² Ω·cm or less. Therefore, it is preferable that the insulator 10 has a resistivity R1 of 3.0×10¹² Ω·cm or less and satisfies equation (3). It is more preferable that the insulator 10 has a resistivity R1 of 3.0×10¹² Ω·cm or less and satisfies equation (4).

When the resistivity R1 is 3.0×10¹² Ω·cm or less, and/or when the above equation (3) is satisfied, the insulator 10 can be used for insulating electrical equipment with the nominal voltage of 345 kV or less, as described above. In this case, the insulator 10 is particularly suitable for insulating electrical equipment with a nominal voltage of any value of 275 kV or more and 345 kV or less, or for insulating electrical equipment with a nominal voltage of any value of 330 kV or more and 345 kV or less. Of course, the insulator 10 in this case can also be used for insulating electrical equipment with the nominal voltage of 161 kV or less.

In addition, the lower the resistivity R1, the more the electric field concentration around the interface 34a can be mitigated, and the lower the resistivity R2, the smaller the resistance ratio Rr becomes, so that equations (1)to (4) are easily satisfied and the electric field concentration around the interface 34b can be mitigated. However, the lower limits of the resistivity R1 and the resistivity R2 are set to values such that the insulator 10 as a whole has the resistance value required for insulation. In addition, even if the resistivity R1 and R2 are low, if the lengths L1 and L2 are large, the resistance value of the housing 30 as a whole becomes high, so the resistivity R1 and R2 are set so that the housing 30 as a whole has the resistance value required for insulation, taking into account the lengths L1 and L2. For example, the resistance value of the insulator 10 as a whole (the resistance value between the first end fitting 41 and the second end fitting 42) is preferably 1 MΩ or more per 1 kV of the nominal voltage of the electrical equipment to be insulated.

The resistivity R1 and R2 described above are values measured in accordance with JIS K 6911.

The portion of the housing 30 that is positioned at lower side than the first region 31, i.e., the portion of the housing 30 that is inserted into the insertion bore 43a and is covered by the first end fitting 41, is made of the same material and has the same resistivity as the first region 31 and is integrally formed with the first region 31. Similarly, the portion of the housing 30 that is positioned at upper side than the second region 32, i.e., the portion of the housing 30 that is inserted into the insertion bore 43a and is covered by the second end fitting 42, is made of the same material and has the same resistivity as the second region 32 and is integrally formed with the second region 32.

The resistivity R1 of the first region 31 of the housing 30 can be adjusted by including a low-resistance material with low resistivity in the first region 31 in addition to the polymer material described above, for example. As the low-resistance material, at least one of carbon black, carbon nanotubes, metal powder, metal fibers, and carbon fibers can be used, for example. As the material of metal powder or metal fiber, at least one metal selected from silver, copper, nickel, aluminum, and zinc can be used. These metals may be in the form of a single metal, an alloy, an oxide, an iodide, or a halide. Such materials for adjusting the resistivity of the housings 30 and methods for manufacturing them are publicly known and are described, for example, in JP 3602634B. If the first region 31 contains a higher proportion of the low-resistance material compared to the second region 32, the resistivity R1 can be made smaller than the resistivity R2. Therefore, not only the first region 31 but also the second region 32 may contain the low-resistance material. This allows adjustment of the resistivity R2 or the resistance ratio Rr. In addition, the resistance ratio Rr can be adjusted by making the polymer materials that are the main components of the first region 31 and the second region 32 different. However, in the present embodiment, the second region 32 does not contain the low-resistance material. That is, in the present embodiment, the polymer material that is the main component of both the first region 31 and the second region 32 is the same, and the resistivity R1 and the resistance ratio Rr are adjusted by adjusting the content ratio of the low-resistance material in the first region 31. In the present embodiment, the low-resistance material is carbon black. For example, the resistance ratio Rr may be 4.0 or less, or 3.0 or less. For example, the resistance ratio Rr may be 0.5 or more, and may be 1.0 or more.

As illustrated in FIG. 1, the uppermost of the sheds 38 of the first region 31 is the large diameter shed 38a, and the lowermost of the sheds 38 of the second region 32 is the small diameter shed 38b. Therefore, in the present embodiment, the diameter of the shed 38 located closest to the second region 32 in the first region 31, i.e., the diameter of the large diameter shed 38a, is larger than the diameter of the shed 38 located closest to the first region 31 in the second region 32, i.e., the diameter of the small diameter shed 38b. When the diameter of the shed 38 located closest to the second region 32 in the first region 31 is large, the electric field tends to be concentrated at the tip of this shed 38 (the end of the portion having the largest diameter in this shed 38). In this manner, contrary to the above, as compared to the case where the diameter of the shed 38 located closest to the second region 32 in the first region 31 is smaller than the diameter of the shed 38 located closest to the first region 31 in the second region 32, the electric field concentration around the interface 34b can be mitigated when the first end fitting 41 is used as the energized end.

The length L1 may be, for example, 709 mm or more. The length L1 may be, for example, 3143 mm or less. The length L2 may be, for example, 10 mm or more. The length L2 may be, for example, 2164 mm or less. The diameter of the trunk portion 36 may be, for example, 20 mm or more. The diameter of the trunk portion 36 may be, for example, 50 mm or less, or 30 mm or less. The diameter of the shed 38 may be, for example, 100 mm or more. The diameter of the shed 38 may be, for example, 200 mm or less, or 140 mm or less. The diameter of the large diameter shed 38a may be 130 mm or more, for example. The diameter of the large diameter shed 38a may be 200 mm or less, for example, and may be 140 mm or less. The diameter of the small diameter shed 38b may be 100 mm or more, for example. The diameter of the small diameter shed 38b may be, for example, 110 mm or less. The number of sheds 38 per 1 m of axial length may be, for example, 30 or more per meter. The number of sheds 38 per 1 m of axial length may be, for example, 35 or less per meter.

When the insulator 10 is used for insulating electrical equipment with the nominal voltage of 161 kV or less, the length L1 may be, for example, 1193 mm or less. The length L2 may be, for example, 484 mm or less. When the insulator 10 is used for insulating electrical equipment with the nominal voltage of 345 kV or less, the length L1 may be, for example, 979 mm or more.

An example of manufacturing the insulator device 1 is described. First, the core 20 is formed by a well-known method. Next, a housing 30 is formed on the outer periphery of the core 20, for example by a known injection molding method. Specifically, rubber containing the above-mentioned polymer material and low-resistance material as raw material for the first region 31, is prepared, the region of the core 20 that forms the first region 31 is sandwiched in a mold, and the rubber is injected from the mold inlet and cured to form the first region 31 of the housing 30 on the outer periphery of the core 20. Similarly, rubber as raw material for the second region 32 is prepared, the region of the core 20 that forms the second region 32 is sandwiched between a mold, and the rubber is injected from the mold inlet and cured to form the second region 32 on the outer circumference of the core 20 so that the second region 32 is in contact with the first region 31. Either the first region 31 or the second region 32 may be formed first. When the housing 30 is formed on the outer periphery of the core 20 in this manner, the both ends of the core 20 and the housing 30 are inserted into the insertion bore 43a of the first end fitting 41 and the insertion bore 43a of the second end fitting 42, respectively, and the outer peripheral surfaces of the main body 43 of the first end fitting 41 and the main body 43 of the second end fitting 42 are tightened respectively with dies to obtain the insulator 10. After manufacturing the insulator 10 in this manner, a connection member 50 is attached to each of the two ends of the insulator 10 to obtain the insulator device 1.

According to the insulator 10 of the present embodiment described in detail above, the housing 30 has the first region 31 and the second region 32, and the resistivity R1 of the first region 31 is lower than the resistivity R2 of the second region 32. With this configuration, it is possible to mitigate the electric field concentration around the interface between the first end fitting 41 and the housing 30, that is, around the interface 34a between the first end fitting 41 and the first region 31.

In addition, the diameter of the shed 38 located closest to the second region 32 in the first region 31, i.e., the diameter of the large diameter shed 38a, is larger than the diameter of the shed 38 located closest to the first region 31 in the second region 32, i.e., the diameter of the small diameter shed 38b. In this manner, the electric field concentration around the interface 34b can be mitigated when the first end fitting 41 is used as the energized end.

Furthermore, since the resistivity R1 is 6.0×10¹² Ω·cm or less, when the insulator 10 is used for insulating electrical equipment with the nominal voltage of 161 kV or less (e.g., insulating between the transmission line and the steel tower mentioned above), the electric field concentration around the interface 34a is sufficiently mitigated. In addition, since the relationship between the length L1 of the first region 31 and the resistance ratio Rr satisfies equation (1), the electric field concentration around the interface 34b can be mitigated when the insulator 10 is used for insulating electrical equipment with the nominal voltage of 161 kV or less. Furthermore, by satisfying equation (2), the electric field concentration around the interface 34b can be further mitigated.

Furthermore, since the resistivity R1 is 3.0×10¹² Ω·cm or less, when the insulator 10 is used for insulating electrical equipment with the nominal voltage of 345 kV or less (e.g., the insulation between the transmission line and the steel tower described above), the electric field concentration around the interface 34a is sufficiently mitigated. In addition, since the relationship between the length L1 of the first region 31 and the resistance ratio Rr satisfies equation (3), the electric field concentration around the interface 34b can be mitigated when the insulator 10 is used for insulating electrical equipment with the nominal voltage of 345 kV or less. Furthermore, by satisfying equation (4), the electric field concentration around the interface 34b can be further mitigated.

It should be noted that the present invention is not limited to the present embodiment described above in any way, and it goes without saying that the present invention can be implemented in various modes as long as they fall within the technical scope of the present invention.

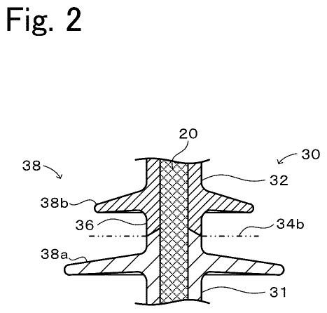

For example, in the above-described embodiment, the interface 34b between the first region 31 and the second region 32 is a surface perpendicular to the axial direction of the core 20, as shown in the cross-sectional view at the upper right of FIG. 1, but the present invention is not limited thereto. The interface 34b may be inclined from the direction perpendicular to the axial direction of the core 20. For example, as shown in FIG. 2, the upper end of the first region 31 may be inclined so as to extend into the interior of the second region 32. In FIG. 2, the upper end surface (i.e., interface 34b) of the first region 31 is inclined in a shed shape, and the upper end portion of the first region 31 has a shape that protrudes toward the second region 32 (upper side) in a position closer to the center axis (core 20) and extends into the interior of the second region 32. When manufacturing a housing 30 with such a shape, the first region 31 may be formed first, and then the second region 32 may be formed so as to cover the upper end portion of the first region 31. Contrary to FIG. 2, the lower end of the second region 32 may have a shape so as to extend into the interior of the first region 31.

In the above-described embodiment, the interface 34b is located at the trunk portion 36 of the housing 30, but the present invention is not limited thereto. The interface 34b may be located at the shed 38.

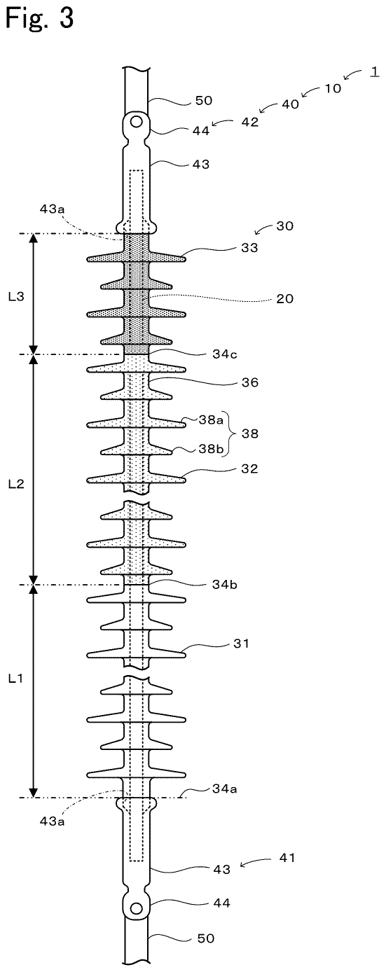

In the above-described embodiment, the housing 30 has two regions, the first region 31 and the second region 32, but the present invention is not limited thereto. The housing 30 may have three or more regions arranged along the axial direction. FIG. 3 is an explanatory diagram showing a case where the housing 30 has a third region 33. In FIG. 3, the housing 30 has a third region 33 provided at a position adjacent to the second region 32 and closer to the second end fitting 42 than the second region 32 in the axial direction. The second region 32 and the third region 33 are in contact with each other in the up-down direction at the interface 34c. The position of the upper end of the third region 33 is the same as the position of the lower end of the second end fitting 42. The sum of the length L1, the length L2, and a length L3 [mm] of the third region 33 in the axial direction is equal to the distance between the first end fitting 41 and the second end fitting 42. A resistivity R3 [Ω·cm] of the third region 33 is preferably higher than the resistivity R2 [Ω·cm] of the second region 32. In other words, it is preferable that R1<R2<R3. In this manner, by making the resistivity of the first region 31, the second region 32, and the third region 33 of the housing 30 increase in this order, it is possible to increase the resistivity R3 of the third region 33 and thereby to increase the resistance value of the insulator 10 as a whole, while the difference between the resistivity R1 and the resistivity R2 (e.g., the resistance ratio Rr mentioned above) can be made small, and the difference between the resistivity R2 and the resistivity R3 can be made small. Therefore, compared to a case where the housing 30 has only the first region 31 and the second region 32, it is easy to obtain both the effect of mitigating the electric field concentration around the interface 34a by lowering the resistivity R1 of the first region 31, and the effect of mitigating an electric field concentration around the interface (here, the boundaries 34b and 34c) between regions of the housing 30 having different resistivities. Even when the housing 30 has four or more regions, it is preferable that the resistance values of each of the four or more regions increase from the first end fitting 41 toward the second end fitting 42.

In the above-described embodiment, the sheds 38 has the large diameter shed 38a and the small diameter shed 38b with different diameters, but all of the plurality of sheds 38 may have the same diameter, and the housing 30 may have three or more types of sheds with different diameters. In the above-described embodiment, the large diameter sheds 38a and the small diameter sheds 38b are arranged alternately one by one along the axial direction, but the present invention is not limited thereto. Other arrangement patterns may be adopted, such as arranging one large diameter shed 38a and two small diameter sheds 38b alternately.

In the above-described embodiment, the first end fitting 41 may have a grading ring for suppressing corona discharge. However, since the insulator 10 of the above-described embodiment can suppress the electric field concentration at the interface 34a by having the housing 30 with the first region 31 and the second region 32, the grading ring can be made smaller or omitted compared to the case where the first region 31 and the second region 32 are not provided.

### EXAMPLES

Specifically fabricated examples of the insulator 10 will be described as example. Experimental Examples 2 to 34 correspond to examples of the present invention, and Experimental Example 1 corresponds to a comparative example. It should be noted that the present invention is not limited to the following example.

### Experimental Examples 1 to 4

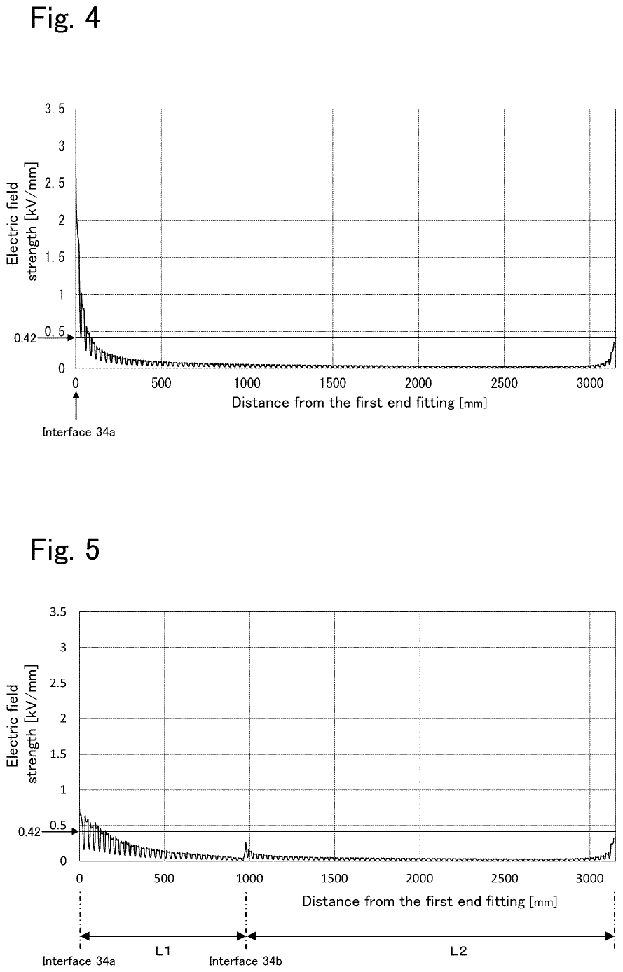

Insulators 10 with various modifications of the housing 30 illustrated in FIG. 1 are referred to as Experimental Examples 1 to 4. For each of Experimental Examples 1 to 4, the distribution of electric field strength was investigated when a voltage of 345 kV was applied between the first end fitting 41 and the second end fitting 42 with the first end fitting 41 as the energized end. Experimental Example 1 shows an insulator 10 in which, unlike FIG. 1, the housing 30 does not have the first region 31 and the second region 32, that is, the resistivity is the same throughout the entire housing 30. Experimental Example 2 shows an insulator 10 in which the housing 30 has the first region 31 and the second region 32, as in FIG. 1. The resistivity R2 in Experimental Example 2 is the same as the resistivity of the housing 30 in Experimental Example 1, and the resistivity R1 in Experimental Example 2 is set to a value lower than that of resistivity R2. Experimental Example 3 shows an insulator 10 in which the resistivity R1 is changed to a lower value than the resistivity R1 in Experimental Example 2. Experimental Example 4 shows an insulator 10 in which the resistivities R1 and R2 are different from the resistivities R1 and R2 in Experimental Examples 2 and 3, and the distance L1 is longer. The distributions of electric field strengths of each insulator 10 in Experimental Examples 1 to 4 are illustrated in FIGS. 4 to 7. In FIGS. 4 to 7, the horizontal axis indicates the distance [mm] from the first end fitting 41, i.e., the distance in the axial direction from the interface 34a, and the vertical axis indicates the electric field strength [kV/mm]. In addition, the Electric Power Research Institute (EPRI) proposes a target for composite insulators of “the length of the area where the electric field strength on the rubber surface continuously exceeds 0.42 kV/mm shall be less than 10 mm.” Therefore, FIGS. 4 to 7 also show a straight line indicating the electric field strength of 0.42 kV/mm.

As illustrated in FIG. 4, in Experimental Example 1, which does not have the first region 31 and the second region 32, the electric field strength around the interface 34a (the interface between the end of the first end fitting 41 and the housing 30, i.e., the position where the distance from the first end fitting 41 is 0 mm) was high, at 3.0 kV/mm or more, and electric field concentration around the interface 34a was confirmed. On the other hand, as illustrated in FIGS. 5 to 7, in Experimental Examples 2 to 4, which have the first region 31 and the second region 32, the electric field strength around the interface 34a, i.e., the position at the distance of 0 mm from the first end fitting 41, was lower than the electric field strength in Experimental Example 1, and thereby the electric field concentration was mitigated. From this, it was confirmed that the electric field concentration around interface 34a can be mitigated by providing the first region 31, which has a lower resistivity than the second region 32. This is considered to be because the resistivity R1 of the first region 31 in Experimental Examples 2 to 4 was lower than the resistivity of the housing 30 in Experimental Example 1, and therefore the difference between a resistivity of the first end fitting 41 (which is very low because the first end fitting 41 is a conductor) and the resistivity R1 was small, that is, the change in resistivity along the axial direction around interface 34a was smaller in Experimental Examples 2 to 4 than in Experimental Example 1.

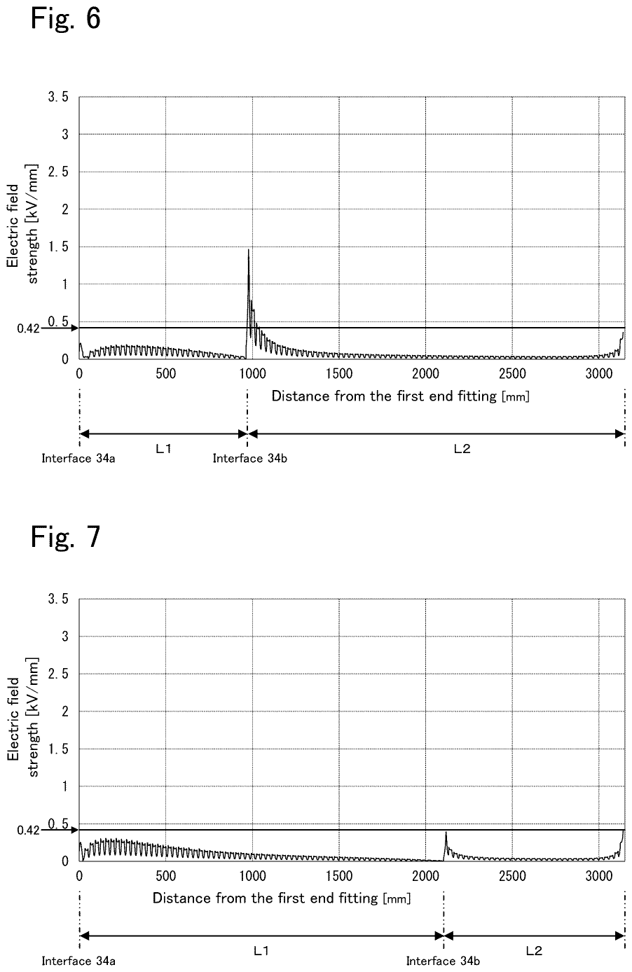

As can be seen from a comparison of FIG. 5 and FIG. 4, in contrast to Experimental Example 1, a slight electric field concentration was observed at interface 34b in Experimental Example 2. Furthermore, as can be seen from a comparison of FIG. 5 and FIG. 6, in Experimental Example 3, in which the resistivity R1 was made lower than in Experimental Example 2, the electric field concentration around interface 34a was mitigated, and the maximum of the electric field strength was less than 0.42 kV/mm. On the other hand, in Experimental Example 3, the electric field was more concentrated around interface 34b than in Experimental Example 2. This is considered to be because the resistivity R1 was lower in Experimental Example 3 than in Experimental Example 2, and therefore the difference between resistivity R1 and resistivity R2 was larger in Experimental Example 3 than in Experimental Example 2, that is, the change in resistivity along the axial direction around interface 34b was larger in Experimental Example 3 than in Experimental Example 2. Then, as illustrated in FIG. 7, in Experimental Example 4, the electric field concentration at interface 34a was mitigated compared to that in Experimental Example 2, and the electric field concentration at interface 34b was mitigated compared to that in Experimental Example 3. More specifically, in Experimental Example 4, the maximum of the electric field strength was less than 0.42 kV/mm at both interface 34a and interface 34b, and there was no portion where the maximum of the electric field strength exceeded 0.42 kV/mm over the entire insulator 10. Therefore, it was confirmed that by adjusting not only the resistivity R1 but also the resistivity R2 and the distance L, both the electric field concentration at interface 34a and the electric field concentration at interface 34b could be mitigated. The same tendency as in Experimental Examples 1 to 4 was confirmed when the voltage of 161 kV was applied between the first end fitting 41 and the second end fitting 42.

### Experimental Examples 5 to 7

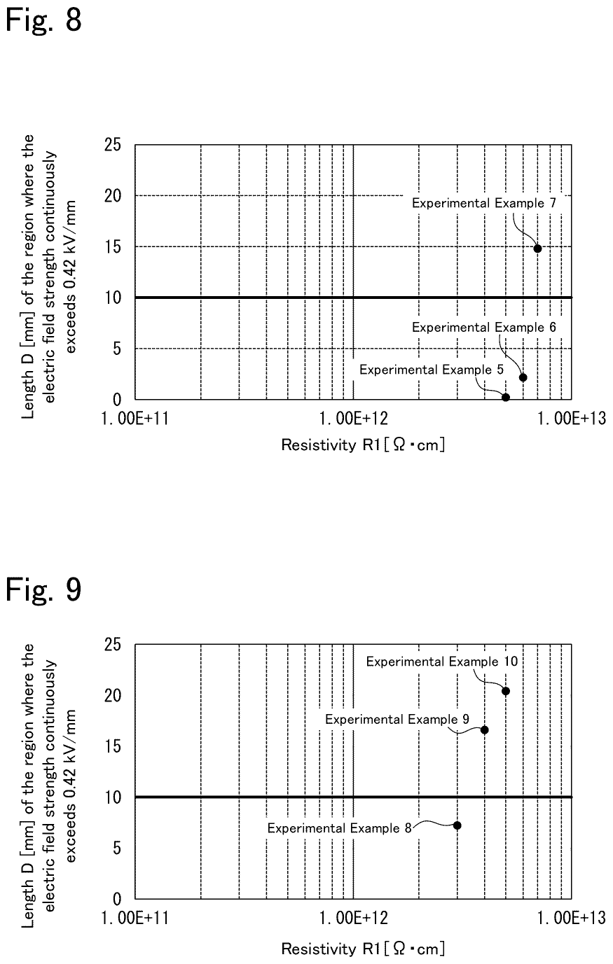

Insulators 10 that had the housing 30 with the first region 31 and the second region 32 and had the same configuration except for having different resistivity R1 each other are referred to as Experimental Examples 5 to 7. Specifically, in Experimental Example 5, the resistivity R1 was 5.0×10¹² [Ω·cm], in Experimental Example 6, the resistivity R1 was 6.0×10¹² Ω·cm, and in Experimental Example 7, the resistivity R1 was 7.0×10¹² Ω·cm. For each of Experimental Examples 5 to 7, the distribution of electric field strength was investigated when the voltage of 161 kV was applied between the first end fitting 41 and the second end fitting 42 with the first end fitting 41 as the energized end. Then, based on the distribution of the electric field strength, the length [mm] of the region where the electric field strength continuously exceeds 0.42 kV/mm in the vicinity of interface 34a (the length along the axial direction of the core 20) was investigated for each of Experimental Examples 5 to 7. Hereinafter, the “length of the region where the electric field strength continuously exceeds 0.42 kV/mm” may be referred to as length D. The smaller the length D, the more the electric field concentration is mitigated. If this length D is less than 10 mm, the above-mentioned target of the Electric Power Research Institute (EPRI) is achieved. FIG. 8 shows the relationship between the resistivity R1 and the length D in each of Experimental Examples 5 to 7.

### Experimental Examples 8 to 10

As in Experimental Examples 5 to 7, insulators 10 that had the housing 30 with the first region 31 and the second region 32 and had the same configuration except for having different resistivity R1 each other are referred to as Experimental Examples 8 to 10. Specifically, in Experimental Example 8, the resistivity R1 was set to 3.0×10¹² Ω·cm, in Experimental Example 9, the resistivity R1 was set to 4.0×10¹² Ω·cm, and in Experimental Example 10, the resistivity R1 was set to 5.0×10¹² Ω·cm. For each of Experimental Examples 8 to 10, the distribution of electric field strength was investigated when the voltage of 345 kV was applied between the first end fitting 41 and the second end fitting 42 with the first end fitting 41 as the energized end. Then, based on the distribution of electric field strength, the length D [mm] in the vicinity of the interface 34a was investigated for each of Experimental Examples 8 to 10. FIG. 9 shows the relationship between the resistivity R1 and the length D for each of the Experimental Examples 8 to 10.

As can be seen from FIG. 8 and FIG. 9, it was confirmed that in both cases where the applied voltage was 161 kV and 345 kV, the lower the resistivity R1, the smaller the length D became, and the electric field concentration around the interface 34a tended to be mitigated. In addition, when the applied voltage was 161 kV, the length D was 10 mm or more in Experimental Example 7, where the resistivity R1 was 7.0×10¹² Ω·cm, while the length D was less than 10 mm in Experimental Examples 5 and 6, where the resistivity R1 was 6.0×10¹² Ω·cm or less, and the above-mentioned target was achieved in Experimental Examples 5 and 6. From these results, it was confirmed that when insulator 10 is used for insulation of electrical equipment with the nominal voltage of 161 kV or less, it is preferable to set the resistivity R1 to 6.0×10¹² Ω·cm or less. When the applied voltage was 345 kV, Experimental Examples 9 and 10, in which the resistivity R1 was 4.0×10¹² Ω·cm or more, had a length D of 10 mm or more, whereas Experimental Example 8, in which the resistivity R1 was 3.0×10¹² Ω·cm or less, had a length D of less than 10 mm and achieved the above-mentioned target. From these results, it was confirmed that when insulator 10 is used for insulation of electrical equipment with the nominal voltage of 345 kV or less, it is preferable to set the resistivity R1 to 3.0×10¹² Ω·cm or less. Furthermore, comparison of FIG. 8 and FIG. 9 confirms that the higher the applied voltage, the lower the upper limit of resistivity R1 required to achieve the target. This is considered to be because the higher the applied voltage, the easier it is for the electric field to concentrate around interface 34a, and therefore it is necessary to lower resistivity R1 (i.e., bring resistivity R1 closer to the resistivity of the first end fitting 41) in order to mitigate electric field concentration.

### Experimental Examples 11 to 21

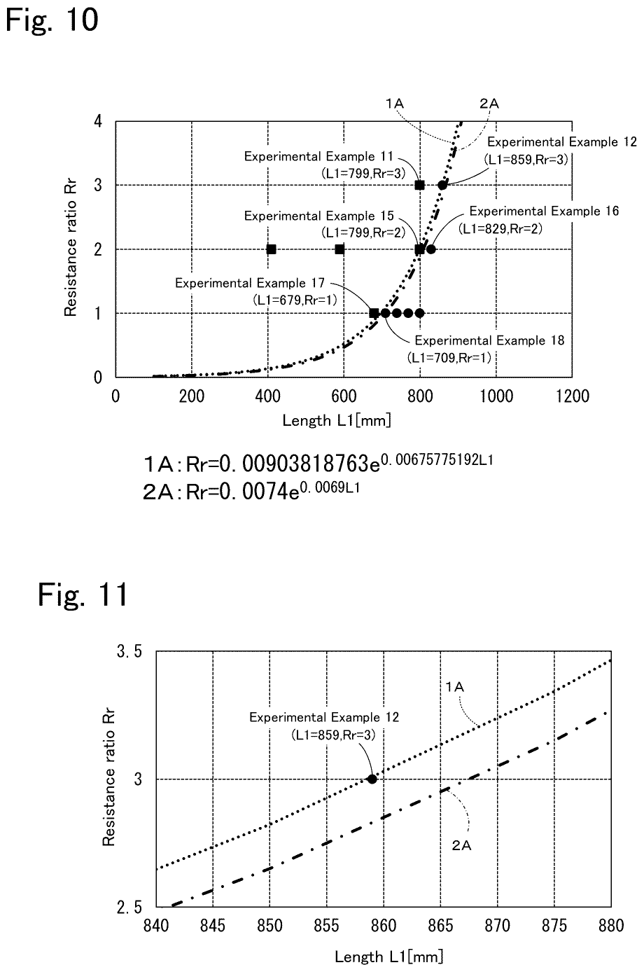

Except for various changes in length L1 and resistance ratio Rr, insulators 10 of the same configuration were used in Experimental Examples 11 to 21. For each of Experimental Examples 11 to 21, the distribution of electric field strength was investigated when the voltage of 161 kV was applied between the first end fitting 41 and the second end fitting 42 with the first end fitting 41 as the energized end. Then, based on the distribution of the electric field strength, the length D [mm] around the interface 34b was investigated for each of Experimental Examples 11 to 21, and if the length D was less than 10 mm, the target was evaluated as achieved, and if it was 10 mm or more, the target was evaluated as not achieved. FIG. 10 shows a graph plotting the length L1 and resistance ratio Rr for each of Experimental Examples 11 to 21. In FIG. 10, the Experimental Examples that were judged to have achieved the target are indicated by circles, and the Experimental Examples that were judged to have failed to achieve the target are indicated by squares.

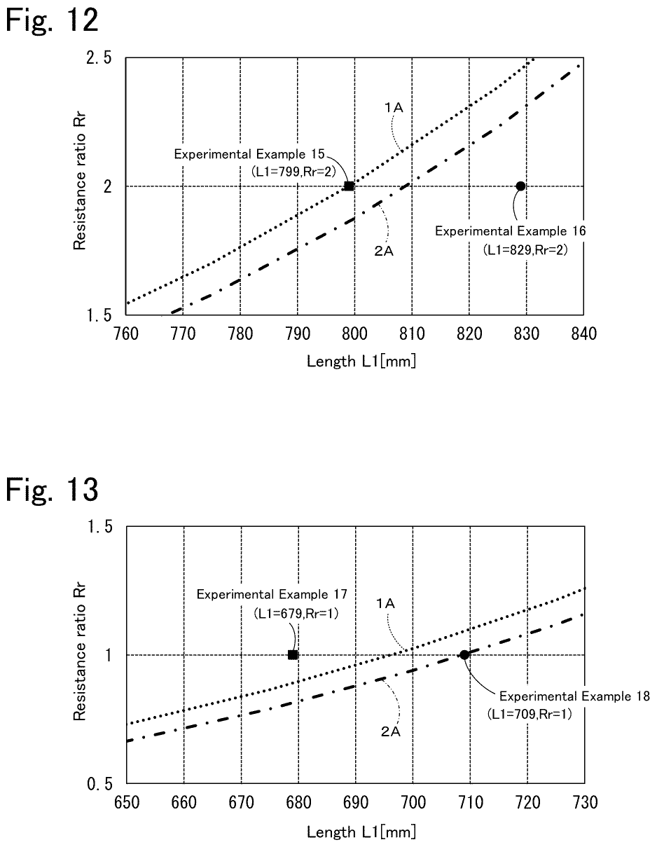

As illustrated in FIG. 10, when comparing Experimental Examples with the same resistance ratio Rr, it was confirmed that the longer the length L1, the easier it was to achieve the target (i.e., the electric field concentration at interface 34b could be mitigated more). This is considered to be because the longer the length L1, the further the interface 34b between the first region 31 and the second region 32 is separated from the first end fitting 41 on the energized end. In addition, when comparing Experimental Examples with lengths L1 that were the same or close to each other, it was confirmed that the smaller the resistance ratio Rr, the easier it was to achieve the target. This is considered to be because the smaller the resistance ratio Rr, i.e., the closer the resistivity R1 and resistivity R2 are to each other, the smaller the change in resistivity along the axial direction around the interface 34b. Furthermore, it was confirmed that one value of length L1 and resistance ratio Rr affects the preferred range of the other value, such as the target can be achieved even if the resistance ratio Rr is large when the length L1 is long. It was also confirmed that the lower right region of FIG. 10, that is, where the length L1 is longer and the resistance ratio Rr is smaller, tends to facilitate achieving the target. Based on the results shown in FIG. 10, approximate curves were derived to indicate a boundary between Experimental Examples that were judged to have failed to achieve the target and Experimental Examples that were judged to have achieved the target. The broken line in FIG. 10 is an approximate curve derived from the three Experimental Examples 11, 15, and 17 that were judged to have failed to achieve the target, and the single-dotted chain line is an approximate curve derived from the three Experimental Examples 12, 16, and 18 that were judged to have achieved the target. The approximate curve shown by the broken line in FIG. 10 was given by the following equation (1A), and the approximate curve shown by the single-dotted chain line was given by the following equation (2A). Since it is considered that the target can be achieved when the relationship between the resistance ratio Rr and the length L1 in the insulator 10 is located in the region to the right and below the broken line in FIG. 10, the above equation (1) was determined based on the following equation (1A). The approximate curve shown by the broken line in FIG. 10, i.e., equation (1A), was determined so as to pass through a region slightly lower right than Experimental Examples 11, 15, and 17. Therefore, the region lower right than equation (1A) in FIG. 10, i.e., the region that satisfies equation (1), does not include Experimental Examples 11, 15, and 17, which were judged to have failed to achieve the target. In addition, since it is considered that the target can be more reliably achieved when the relationship between the resistance ratio Rr and the length L1 in the insulator 10 is located in the region to the right and below the single-dotted chain line in FIG. 10, the above equation (2) was determined based on the following equation (2A). FIGS. 11 to 13 are partial enlarged views for showing the positional relationship between the Experimental Examples near the approximate curves in FIG. 10 and the approximate curves.

$$Rr = 0.00903818763 {e}^{0.00675775192 L 1} \qquad ( 1 A )$$

$$Rr = 0.0074 {e}^{0.0069 L 1} \qquad ( 2 A )$$

### Experimental Examples 22 to 34

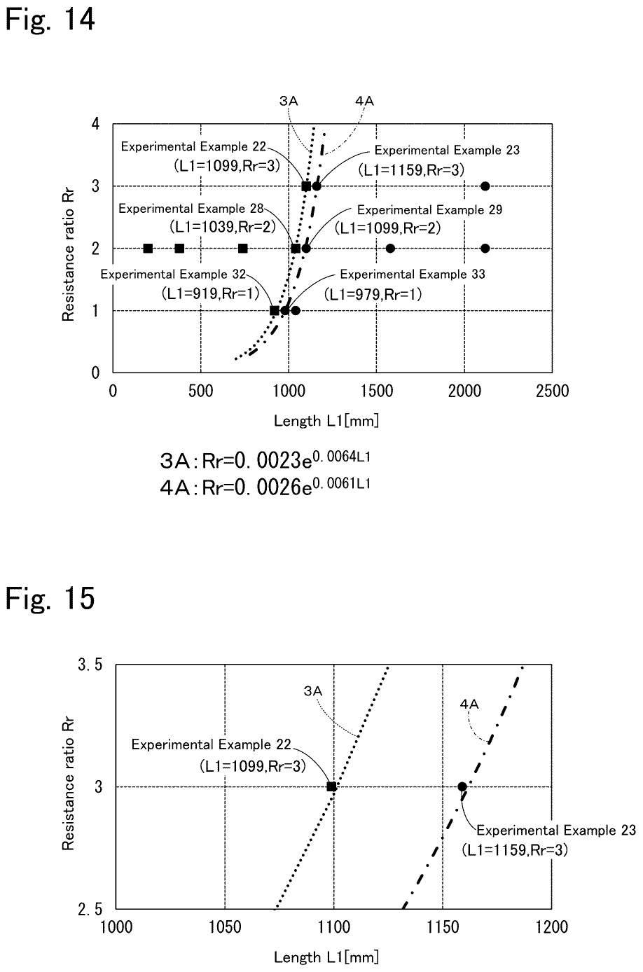

As in Experimental Examples 11 to 21, except for various changes in length L1 and resistance ratio Rr, insulators 10 of the same configuration were used in Experimental Examples 22 to 34. For each of Experimental Examples 22 to 34, the distribution of electric field strength was investigated when the voltage of 345 kV was applied between the first end fitting 41 and the second end fitting 42 with the first end fitting 41 as the energized end. Then, based on the distribution of electric field strength, the length D [mm] around the interface 34b was investigated for each of Experimental Examples 22 to 34, and if the length D was less than 10 mm, the target was evaluated as achieved, and if it was 10 mm or more, the target was evaluated as not achieved. FIG. 14 shows a graph plotting the length L1 and resistance ratio Rr for each of Experimental Examples 22 to 34. In FIG. 14, Experimental Examples that were judged to have achieved the target are indicated by circles, and Experimental Examples that were judged not to have achieved the target are indicated by squares.

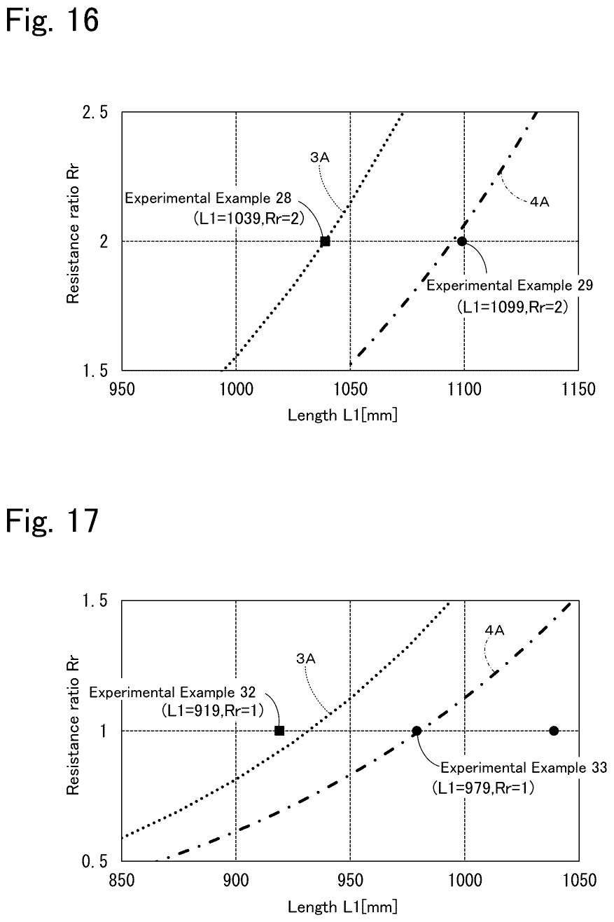

As illustrated in FIG. 14, the same trend as in FIG. 10 was confirmed when the applied voltage was 345 kV. That is, it was confirmed that the longer the length L1, the easier it was to achieve the target (i.e., the electric field concentration at interface 34b could be mitigated more). When comparing Experimental Examples with lengths L1 that were the same or close to each other, it was confirmed that the smaller the resistance ratio Rr, the easier it was to achieve the target. It was confirmed that one value of length L1 and resistance ratio Rr affects the preferred range of the other value, such as the target can be achieved even if the resistance ratio Rr is large when the length L1 is long. It was confirmed that the lower right region of FIG. 14, that is, where the length L1 is longer and the resistance ratio Rr is smaller, tends to facilitate achieving the target. Based on the results shown in FIG. 14, approximate curves were derived to indicate a boundary between Experimental Examples that were judged to have failed to achieve the target and Experimental Examples that were judged to have achieved the target. The broken line in FIG. 14 is an approximate curve derived from the three Experimental Examples 22, 28, and 32 that were judged to have failed to achieve the target, and the single-dotted chain line is an approximate curve derived from the three Experimental Examples 23, 29, and 33 that were judged to have achieved the target. The approximate curve shown by the broken line in FIG. 14 was given by the following equation (3A), and the approximate curve shown by the single-dotted chain line was given by the following equation (4A). Since it is considered that the target can be achieved when the relationship between the resistance ratio Rr and the length L1 of the insulator 10 is located in the region to the right and below the broken line in FIG. 14, the above equation (3) was determined based on the following equation (3A). The approximate curve shown by the broken line in FIG. 14, i.e., equation (3A), was determined so as to pass through a region slightly lower right than Experimental Examples 22, 28, and 32. Therefore, the region lower right than equation (3A) in FIG. 14, i.e., the region satisfying equation (3), does not include Experimental Examples 22, 28, and 32, which were judged to have failed to achieve the target. In addition, since it is considered that the target can be more reliably achieved when the relationship between the resistance ratio Rr and the length L1 in the insulator 10 is located in the region to the right and below the single-dotted chain line in FIG. 14, the above equation (4) was determined based on the following equation (4A). FIGS. 15 to 17 are partial enlarged views for showing the positional relationship between the Experimental Examples near the approximate curves in FIG. 14 and the approximate curves.

$$Rr = 0.0023 {e}^{0.0064 L 1} \qquad ( 3 A )$$

$$Rr = 0.0026 {e}^{0.0061 L 1} \qquad ( 4 A )$$

What is claimed is:

1. An insulator comprising:
a core having a rod-shape,
a first end fitting and a second end fitting that secure both ends of the core in an axial direction of the core, and
a housing that covers an outer periphery of a portion of the core, the portion being located between the first end fitting and the second end fitting, the housing having a trunk portion and a plurality of sheds, and being composed of an insulating polymer material as a main component,
wherein the housing includes a first region and a second region, the first region that is provided at a position including an interface between the first end fitting and the housing in the axial direction, and the second region that is provided at a position adjacent to the first region and closer to the second end fitting than the first region in the axial direction, and
the first region has a lower resistivity than the second region.

2. The insulator according to claim 1,
wherein the plurality of sheds has two or more types of sheds with different diameters, and
the diameter of the shed located closest to the second region in the first region is larger than the diameter of the shed located closest to the first region in the second region.

3. The insulator according to claim 1,
wherein the housing has a third region provided at a position adjacent to the second region and closer to the second end fitting than the second region in the axial direction, and
the third region has a higher resistivity than the second region.

4. The insulator according to claim 1,
wherein the insulator is used for insulating electrical equipment with a nominal voltage of 161 kV or less, and
the first region has a resistivity R1 of 6.0×10¹² Ω·cm or less.

5. The insulator according to claim 1,
wherein the insulator is used for insulating electrical equipment with a nominal voltage of 161 kV or less, and
when the length of the first region in the axial direction is defined as L1 [mm], and log₁₀ (R2/R1), which is a common logarithm of a ratio of a resistivity R1 [Ω·cm] of the first region to a resistivity R2 [Ω·cm] of the second region, is defined as a resistance ratio Rr, and e is defined as Napier's constant, the following equation (1) is satisfied:
$$Rr \leq 0.00903818763 {e}^{0.00675775192 L 1} . \qquad ( 1 )$$

6. The insulator according to claim 5,
wherein the following equation (2) is satisfied:
$$Rr \leq 0.0074 {e}^{0.0069 L 1} . \qquad ( 2 )$$

7. The insulator according to claim 1,
wherein the insulator is used for insulating electrical equipment with a nominal voltage of 345 kV or less, and
the first region has a resistivity R1 of 3.0×10¹² Ω·cm or less.

8. The insulator according to claim 1,
wherein the insulator is used for insulating electrical equipment with a nominal voltage of 345 kV or less, and
when the length of the first region in the axial direction is defined as L1 [mm], and log₁₀ (R2/R1), which is a common logarithm of a ratio of a resistivity R1 [Ω·cm] of the first region to a resistivity R2 [Ω·cm] of the second region, is defined as a resistance ratio Rr, and e is defined as Napier's constant, the following equation (3) is satisfied:
$$Rr \leq 0.0023 {e}^{0.0064 L 1} . \qquad ( 3 )$$

9. The insulator according to claim 8,
wherein the following equation (4) is satisfied:
$$Rr \leq 0.0026 {e}^{0.0061 L 1} . \qquad ( 4 )$$

10. The insulator according to claim 4,
wherein the insulator is used for insulating electrical equipment with a nominal voltage of 161 kV or less, and
when the length of the first region in the axial direction is defined as L1 [mm], and log₁₀ (R2/R1), which is a common logarithm of a ratio of a resistivity R1 [Ω·cm] of the first region to a resistivity R2 [Ω·cm] of the second region, is defined as a resistance ratio Rr, and e is defined as Napier's constant, the following equation (1)is satisfied:
$$Rr \leq 0.00903818763 {e}^{0.00675775192 L 1} . \qquad ( 1 )$$

11. The insulator according to claim 10,
wherein the following equation (2) is satisfied:
$$Rr \leq 0.0074 {e}^{0.0069 L 1} . \qquad ( 2 )$$

12. The insulator according to claim 7,
wherein the insulator is used for insulating electrical equipment with a nominal voltage of 345 kV or less, and
when the length of the first region in the axial direction is defined as L1 [mm], and log₁₀ (R2/R1), which is a common logarithm of a ratio of a resistivity R1 [Ω·cm] of the first region to a resistivity R2 [Ω·cm] of the second region, is defined as a resistance ratio Rr, and e is defined as Napier's constant, the following equation (3) is satisfied:
$$Rr \leq 0.0023 {e}^{0.0064 L 1} . \qquad ( 3 )$$

13. The insulator according to claim 12, wherein the following equation (4) is satisfied:
$$Rr \leq 0.0026 {e}^{0.0061 L 1} . \qquad ( 4 )$$
